(19) United States
(12) Patent Application Publication
(10) Pub. No.: US 2007/0134383 A1
(43) Pub. Date: Jun. 14, 2007

(54) Z-Trim combined directly with erythritol

(76) Inventor: Keith Earl Kenyon, Sherman Oaks, CA (US)

Correspondence Address: KEITH E. KENYON, M.D., 4501 NAGLE AVENUE, SHERMAN OAKS, CA, 91423, US

(21) Appl. No.: 11/301,181

(22) Filed: Dec. 12, 2005

(51) Int. Cl. A23L 1/216

(52) U.S. Cl. 426/481

(57) ABSTRACT

This disclosure pertains to combining the zero-calories prebiotic cellulosic fiber, Z-Trim, with the essentially zero-calories polyol, erythritol, and water to have a sweeter replacer or diluter of fats and sugars in foods than the use of Z-Trim alone.

### FIELD OF THE INVENTION

This invention is in the field of food, especially food replacements that do not supply actual nutrition.

### STATEMENT REGARDING FEDERALLY SPONSORED RESEARCH/DEVELOPMENT

The present invention does not involve any form of federally sponsored research or development.

### BACKGROUND OF THE INVENTION

Even before Proctor and Gamble's experiment with the fat replacer, Olestra, there has been a desire to produce a replacement for part of the fat in transfat-rich substances like potato chips. Acrylamide reduction by glucose dilution has added to the impetus lately. The obesity problem along with type 2 diabetes also needs to be addressed by fat and sugar replacers. In this regard frozen desserts and snacks such as ice cream and yogurt plague the acceptability of low calories, low glycemic foods just as much as their warmer counterparts.

Among the most ambitious programs to address this issue has been by the United States Department of Agriculture and its chemist George Inglett, Ph.D. The culmination of this federal effort resulted in the awarding of a patent concerning prebiotic cellulosic fiber in 1998, U.S. Pat. No. 5,766,662, which is herein incorporated by reference in its entirety, and which was assigned to the United States Government and licenses awarded. Unfortunately this product called Z-Trim could not be fried into potato chips so has had to be used only as a fat replacer for a limited number of foods. This disclosure seeks to remedy this lapse in part by rendering Z-Trim in a new combination form that enables it to replace more of the fat both in recipes and as a direct mixer into foods such as dips, mayonnaise and frozen desserts, even at home.

In recent years the danger of postprandial hyperglycemic spikes has been investigated. Professor Antonio Ceriello of the Department of Pathology and Medicine, Experimental and Clinical, University of Udine, Udine, Italy has reported recently that cardiac disease in the diabetic and such postprandial spikes are correlated. Researchers including Dr. Inglett also were aware of this general problem, and he and his team have developed nutritional means to mitigate the danger including this largely amorphous cellulosic product and as such a unique hydrocolloid for food product design, Z-Trim. Z-Trim's gel particles absorb large amounts of water to produce huge deformable structures with high viscosities and a smooth mouth feel. By using Z-Trim, food textures can be adjusted to blend with the product. Their various particle sources and sizes can give textural variation from creaminess to particle-like structure for hamburger, deli-meats, cheeses, and some baked foods. Large reductions in calories are possible along with adding healthful amounts of insoluble fiber to the diet. The ultimate product was this zero-calories prebiotic substance although Inglett was also concerned with beta glucans and used them instead of Z-Trim in an important clinical trial about diabetes mellitus.

Examining this study (American Journal of Therapeutics. V. 10. P.P. 438-443) that Inglett was involved with, and which Z-Trim was not used but rather beta-glucans (also of a low glycemic index) as the fat and carbohydrate replacers, it was stated that the value of such introduction of fat and carbohydrates replacers has been a revolutionary advance in treating obesity and diabetes mellitus. Since these materials have shown to have beneficial effects on the metabolic profiles of diabetic patients, they should be useful in designing specific foods for patients with diabetes. The objective was to compare metabolic and anthropometric improvements elicited by a diet based on the American Diabetic Association's nutrition recommendations with a modified, low-energy diet incorporating fat replacers and non-sucrose sweeteners. A total of 16 male, well controlled type 2 diabetes patients were divided into two groups of eight; one group received the diet based on the American Diabetic Association's nutrition recommendations, and the other was fed a modified, low-calories diet containing a fat replacer (beta-glucans derived from oats) and the sweeteners, sucralose and fructose. Both groups were maintained on their respective diets for 4 weeks. All patients performed daily aerobic exercise consisting of walking for 60 minutes. Body weight, body mass index, basal glycemia, HbAlC, and lipid profile were determined in each patient before starting the diets and after 4 weeks of dietary intervention. A diet incorporating these fat replacer and non-sucrose sweeteners (fructose and synthetic sucralose) produced a greater improvement in metabolic and anthropometric variables in well controlled type 2 diabetic patients when compared with a diet based on the American Diabetic Association's nutrition recommendations. Both diets produced significant improvements in weight, body mass index, lipid profile, basal glucose, and HbAlC. However, the experimental diet was superior to the American Diabetic Association's diet in improving metabolic and anthropometric profile: greater increase in HDL cholesterol and larger decreases in HbAlC, weight, and body mass index.

We have every reason to expect that the cellulosic fiber, Z-Trim, combined with the zero-glycemic sweetener of this disclosure will work even better. Although Z-Trim by itself would not replace the Proctor and Gamble fat replacer, Olestra, there is reason to believe that a product using this disclosure can. Olestra relates to intermediate melting sucrose fatty acid ester compositions that are capable of rapid crystallization from a melted state. The compositions comprise 60% to 97% by weight intermediate melting sucrose fatty acid esters and 3% to 40% hardstock triglycerides or hardstock polyol fatty acid esters. Preferably the average fatty acid chain length of the hardstock material fatty acids is not less than the average fatty acid chain length of the intermediate melting sucrose ester fatty acids, however, since oil soluble vitamins essential for the living body are dissolved into these substances and excreted as such, they have problems such as the limitation in the amount of ingestion. In order for there to be a replacement for Olestra it could not dissolve in fats but rather only be miscible with them so that the intestine receptors could recover the fat soluble nutrients.

This invention is designed, among other things, to overcome the deficiencies of previous applications and inventions by disclosing a new way to employ Z-Trim combined with one or more simple non-saccharide carbohydrates, at least one combination of which will be virtually zero-calories and zero-glycemic index.

### BRIEF SUMMARY OF THE INVENTION

This disclosure seeks to overcome when needed, a present limit in the effectiveness of zero-calories Z-Trim by the fact that it confers no taste to a food it is used with. Such can be done preferably by having it be combined by water to a second single food ingredient that does have a good taste along with bulk and a GRAS designation. Heating the two solids in a microwave or with other standard heating means and mixing the result as needed, can be done because water will be drawn in from the atmosphere, but mixing with water in the first place is preferable for best uniformity or homogenization of the results. Placing the two solids into a mechanical blender with water then blending them at room temperature is another means to prepare and homogenize the product.

On the basis of cost-effectiveness as well as preferable taste, the choice between either of the two can be made as well as using the two procedures together in the same processing sequence to produce the preferred product for packaging either in bulk or small packages. Obtaining a good taste by the combination of the two solids plus water will confer a benefit and expand its use over either one used alone and is the prime objective of this disclosure, especially if the second solid is also zero-calories. Of course the two ingredients can be combined by mixing with water at room temperature and nothing else done, but the result is less uniform or homogenized.

Such a nutrient ingredient combination could have the capability even of being eaten by itself depending on the strength of the good-tasting part of the combination. Regardless of the relative strengths of the two solid ingredients, if each is zero-calories to begin with, any combination will still keep the packaging of them at zero-calories. In other words, if you mixed a single sweet zero-calories substance that has FDA designation as a nutrient ingredient with GRAS status with Z-Trim, it could be used the same way Z-Trim is used, yet reduce the need for sugar in certain recipes advocated for Z-Trim that require sugar and still have other uses in the field of fat and carbohydrate replacement or dilution of which Z-Trim used by itself is not capable of as much dilution of them as the combination would have.

For this sweet second nutrient ingredient, this disclosure further seeks to take advantage of a previously unrealized capability of a number of simple carbohydrates with reduced calories known as polyols that taste sweet, in order to combine one or more of them with this recently discovered cellulosic fiber, Z-Trim, to form a uniform combined substance with bulk being contributed by each solid that better takes advantage of the benefits of Z-Trim's zero-calories status by enabling it to work more satisfactorily in more foods and more completely, the preferred polyol being virtually zero-calories erythritol. Even if we only mix at room temperature, the preferred polyol of this disclosure, erythritol, with Z-Trim, is a more complete fat replacer or diluter, as well as a sugar replacer or diluter, even if it is less homogeneous than would be desired which can be readily remedied. Since the preferred use of Z-Trim particularized solid by itself is to first blend water into it using a blender, by still doing so but adding powdered erythritol and mixing the three components, a homogeneous result will be obtained from the blender which could be packaged the same way as Z-Trim is packaged. The result by either method is superior for fat and sugar dilution than is Z-Trim by itself.

Direct fat dilution or replacement even in such diverse foods as mayonnaise and yogurt can be done directly by simply removing part of the finished food and replacing it with the product of this disclosure. Since one of these products, mayonnaise, would be classified as sour and the other sweet, varying the amount of erythritol would still keep the mayonnaise sour enough with less erythritol and the yogurt sweet enough by more erythritol in the mix, yet provide beneficial bulk to the Z-Trim in either case. Of course, a 50-50 or close to that combination of the two solids would be preferable if only one mix were to be made available. As a result of the zero-fat and/or sugar replacement or dilution of this disclosure, when the same volume of mayonnaise, yogurt, etc. is eaten, the fat and/or sugar is directly reduced proportionately by the zero-calories replacement.

While Z-Trim in its usual packaged form by Fibergel, a division of Circle Group Holdings, Inc., is as an aqueous gel foam-like substance that can be mixed directly into mayonnaise and yogurt, the resulting taste in both foods when 50% dilutions are made is not nearly as good tasting as with this disclosure blended the same way. Therefore, packaging powdered Z-Trim, powdered erythritol and water all mixed together was not anticipated before this disclosure was made and will make a very acceptable new product, because the resulting taste and ease of using is very important in food and its preparation.

Z-Trim by itself is without taste, but, of course, erythritol having a sweet taste mixed in with it confers taste, but it is a good taste that blends in well with the food it is contemplated to be mixed with. Whereas, by dilution Z-Trim by itself will result in less taste, the combination of this disclosure adds good taste so is more likely to be used thereby rendering the zero-calories concept of a fat replacer and by extension a sugar replacer, more ubiquitous, hence improving the public health especially for the obese and diabetics. In U.S. Pat. No. 5,766,662 sugar alcohols are not mentioned although the plural of the word “sugar” is. We would therefore assume that using a sugar alcohol (polyol) in place of sugar (a polyose, i.e. polysaccharide), an entirely different classification of molecule, is new art within the overall context of that patent, and to use the zero-calories polyol, erythritol, combined with zero-calories Z-Trim would be even better than Z-Trim alone.

Such a cellulosic fiber gel substance as Z-Trim can be prepared from soy, oats and other plant foods but preferably from maize by chemically and physically treating the pericarp cell wall substrate in a multistage process to disintegrate their morphological cellular structure. Thermal alkaline degradation is used with impact shear in the first stage followed by alkaline peroxidation and shear in the second stage. The degradation products are removed in the liquid supernatants at each stage. Their high viscosities and hydration capacities characterize the maize fiber gels. After drying, they can be reconstituted by using shear forces to the original gel form. The fiber gels can also be co-dried with hydrophilic materials to make their reconstitution to gel form easier. The alkaline extracted hemicellulose effluents from the fiber gel preparation, including the second stage peroxidized extract, are purified and used as a co-dried hydrophilic material. Also, an amylodextrin, oat flour hydrolysate, can be used as a hydrophilic material.

Of course, sucrose, a disaccharide sugar, is commonly used with Z-Trim in recipes but not packaged with Z-Trim in the way this disclosure teaches using polyols, specifically erythritol, and Circle Group Holdings, Inc. in the filing of published patent application number 20050238781 by Shukla, et al., only cites the use of dextrose specifically, so those skilled in the art that have a license to produce and sell Z-Trim also did not anticipate the novel way polyols, preferably essentially zero-calories erythritol, interact with Z-Trim, to further expand the use of the zero-calories cellulosic fiber of patent No. 5,766,662 by replacing or at least diluting sugar content more effectively than Z-Trim alone when used in recipes. On Dec. 1, 2005 Circle announced contracting with George Foreman Enterprises to market Z-Trim by itself and not Z-Trim combined with erythritol in the same package. Therefore, doing so was not obvious.

Z-Trim combined with erythritol and water at room temperature makes an acceptable product, but boiling it for a relatively short period of time as well as replacing the lost water and mixing it in, even improves the taste more. Z-Trim's prime property is its zero-calories status, and the prime intent of this disclosure is to keep the calorie count of the prepared combination at the lowest calorie level possible. For that erythritol, also called an alternative sugar, is the only such substance that can keep the calories of the resulting fat replacer or diluter at near zero yet confer both bulk and sweetness. Mixed with Z-Trim in the “raw” state it confers acceptable sweetness in 50-50 mixtures but improvement is always desired. As a consequence, heating or boiling makes erythritol sweeter so as to lessen the need for artificial sweeteners such as sucralose even more, which at present is incorporated in formulas employing erythritol such as “Shugr” and in recipes that Cargill publishes that do not employ Z-Trim as well they could have as this disclosure teaches, if such were obvious. Certainly it was not obvious to Cargill to add Z-Trim to their Eridex (erythritol), but it uses other bulk substances such as inulin.

Although the same procedure can be employed with Z-Trim and any other such sugar alcohol if more calories are tolerated, combining Z-Trim with erythritol is the prime intent of this disclosure in order to achieve the lowest calorie combined fat replacer or diluter that can be made. Simplistically when erythritol is combined with Z-Trim and water, it turns into a substance that could in turn either be eaten by itself, including having artificial flavorings added along with sucralose for further sweetening since erythritol supplies the needed bulk, or mixed with ordinary food to render the food of lower calories, as well as having reduced fat and reduced acrylamide where such applies. In the case of frozen desserts or snacks acrylamide formation is not a problem so in this case the major benefit is having reduced fat, sugar and glycemic index for these frozen foods including ice cream, ice milk and yogurt. As mentioned above besides erythritol, such sweet-tasting polyols include but are not limited to xylitol, maltitol, mannitol, sorbitol and lactitol.

In the table below, GI refers to glycemic index, C refers to calories and S to sweetness compared to sucrose.

| POLYOL | GI | C | S |
|---|---|---|---|
| Maltitol | 50 | 3 | 90% |
| Xylitol | 13 | 2.4 | 100% |
| Sorbitol | 9 | 2.5 | 60% |
| Lactitol | 6 | 2 | 40% |
| Mannitol | 0 | 1.5 | 60% |
| Erythritol | 0 | 0 | 70% |

As can be seen by the table only one of the polyols has both zero calories and a zero-glycemic index and that is erythritol so if we want zero calories this is the only polyol that contributes this. On the other hand, the other polyols can contribute for specialized recipes. Most of these substances can be prepared in bulk by fermentation of derivatives from corn, although some can be extracted directly from plants. The fact that Z-Trim is a complex carbohydrate derived from corn, and these are simple polyols of which most can also be derived from corn indicates that this quite common low cost commodity ensures their affordability.

If powdered Z-Trim is mixed with erythritol at room temperature, the two will form a solid mixture that now has sweetness and can be so used. If the two are cooked in the dry state, they remain pretty much the same with respect to taste, but then if water is added, even much more weight of water added than the weight of the two dry substances combined, with cooking or boiling the taste will improve with respect to sweetness. As a result of this heating, the two will become incorporated completely into each other either in a slurry that with further heating becomes a uniform paste or a pockmarked (removable by stirring) conglomerate-appearing substance depending on the amount of water incorporated. At the point that the taste improves to a maximum, heating is discontinued because energy will be expended with no economic gain. For example, if the two are heated on high in a microwave oven long enough the water in the slurry will begin to boil. If the heating is discontinued at this point, the slurry will taste sweeter than before the heating began, then if heating is continued the contents may even increase in sweetness but the process should be stopped while there is still self-contained moisture and not a dried out mass. Depending on whether the Z-Trim is used as a gel-foam or as a powder, this result either becomes a paste-like substance for the Z-Trim gel and a relatively smooth, except for depressed pockmarkings which are obliterated with stirring, conglomerate-like substances for the Z-Trim powder combined with erythritol. Either one can be mixed in with mayonnaise and similar substances, snack dips, and sweet confections that are amendable to the mixing but especially for frozen desserts such as ice cream, ice milk and yogurt. If the raw version needs improvement, the cooked Z-Trim-erythritol combination, hot or cold, can be mixed directly where no other processing is needed but should be served at appropriate temperatures for the food.

Z-Trim is offered at present to the public in the form of a gel-foam that has been hydrated in a blender as well as the dry solid. Erythritol is offered as a powder and the two solids can be mixed at room temperature, but if the two are going to be heated together for production purposes since considerable water is going to be added anyway whether the combination is cooked or not cooked, it may be more cost-effective, not to dry out the two precursors to begin with, but mix them together in the aqueous state and use them either unboiled or boiled by either professionals or at home, already prepared for use, of being added directly to the intended food, dessert or snack.

Although different proportions of each solid ingredient can make a mix, even as low as 10 percent or even one percent for one compared to the other, using close to half Z-Trim and half erythritol by weight before water is added and with or without cooking will result in the simplest universal combination. Mixing this combination with or without appropriate cooking in its preparation can replace ±50% of the food to be eaten which will result in ±half the calories, ±half the glycemic index, ±half the cholesterol, and ±half of the transfats. It will also mean half of the inherent vitamins and minerals, but they can be replaced even by supplements. Since this replacer does not replace green leafy vegetables unless they are ground up, the nutrients therein will not be modified, but when too much food is being eaten reducing the part that can be reduced to one half will be of great benefit to diabetics, the obese, and people who just want to reduce their cholesterol intake.

In the event that more of one of the solids is preferred, the sweet solid will be the most practical one to dominate, because sweet is more in demand than neutral or sour. Therefore, whether mixed at room temperature and used that way, placed in a blender and blended at room temperature, cooked or boiled, or a combination of the procedures, the relative proportions will always be water as the chief ingredient and then usually erythritol as the second by weight and Z-Trim the third by weight when erythritol and Z-Trim are not present at the same weight. Less often will erythritol be present at less weight than Z-Trim.

The features of the present invention which are believed to be novel are set forth with particularity. The present invention, both as to its organization and the manner of operation, together with the further objects and advantages thereof, may be best understood by reference to the following exemplary and non-limiting detailed description of the invention, wherein;

### DETAILED DESCRIPTION OF THE INVENTION NO DRAWINGS

The first embodiment is at room temperature to take equal amounts by weight of Z-Trim and erythritol, add considerable water and mix the contents to form a virtually zero-calories fat replacer or diluter in foods containing fat and a sugar replacer or diluter in foods containing sugar or both. Blending the three contents in a blender will homogenize them into a gel-foam mostly due to the hygroscopy of the Z-Trim. Of course, to have either erythritol or Z-Trim in a different proportion than the other will not change the calories but a minimum of Z-Trim is required to have a blended result similar to when Z-Trim is used alone. The proportions can be changed for taste or if one of the ingredients besides water is more inexpensive than the other, however going above a 2:1 or below a 1:2 ratio is not recommended in most cases. Nevertheless, in certain circumstances it may be useful to go to as low as 10% by weight of the solids being either erythritol or Z-Trim and the other being 90% of the total solids. Under these circumstances of extra high percentage of one or the other, the amount of water added may need to be altered. Since Z-Trim is very hygroscopic and erythritol is not, Z-Trim has no taste and erythritol is sweet, the preferred ratio will be to keep Z-Trim at unity or close to unity and erythritol expanded up to a point, as increasing sweetness is desired. Due to the hygroscopic nature of Z-Trim, water can be added not only for bulk but to improve the mixture for use, and since water per unit is quite inexpensive, it can be added not only for expanded bulk with erythritol but decreased cost/volume. By weight of dry product, erythritol is best present in greater amounts than Z-Trim rather than the reverse. Having considerably less dry weight of erythritol compared to Z-Trim would be of little use, but having more dry weight of erythritol compared to Z-Trim can make the product edible by itself since Z-Trim has no taste. Adding water suits the nature of both for optimum usage because it increases bulk, with the flavor coming from the food being diluted. The erythritol helps keep more of the flavor of the food. The upper limit of added water can be more than 10:1 over the solids

Since considerable variation of the content of each ingredient is possible, an example of the first embodiment could be a combination in which the two solids are unequal by weight but close, so for one we can have multiples of 0.8 gram of Z-Trim per 1.2 grams of erythritol and 6 to 7 grams of water mixed and packaged either as a dry hydrated solid, a wet concentrated slurry or a foam.

The second embodiment is to cook or boil any of the combinations of the first embodiment including the one just mentioned. If only the solids are mixed and heated, water will be picked up from the atmosphere and a hot wet result will occur that has pockmarks throughout but when mixed a uniform combination of the three is achieved, and sweetness is likely improved over the mix before such heating. If water is added and the contents boiled, the pockmarked sludge will still occur until stirring brings about uniformity and homogenization. Water can be added if desired to replace that which was boiled off, but if the contents are ultimately placed in a blender, the results will appear as a gel-foam similar to when Z-Trim is used alone but now the gel-foam is sweeter.

While it may be said that erythritol can be used for cooking purposes, used alone it is not a good product for such purpose and must be accompanied by polydextrose, and/or multodextrin, and/or inulin, and/or tagatose, and/or sucralose. It simply does not perform well by itself. On the other hand, it has never been cooked with another single compatible substance by itself alone. If this is done, then erythritol can become part of a superior substance, the new combination enabling erythritol to be able to used in cooking with much better results. Before we continue with more examples, let us expand on this issue.

When erythritol is combined with the cellulosic fiber, Z-Trim, the two form a common substance that has different physical characteristics than either of them without the other. Z-Trim when mixed with five times its weight of water will absorb the entirety of the water, while erythritol is not a hygroscopic sweetener. Nevertheless, erythritol moves right inside the water that the cellulosic fiber has drawn in. Therefore, the two combined with water have much of the same texture as if the Z-Trim were used entirely by itself. It may be argued that those skilled in the art would have known this, but the fact is that even though the object of inventing and marketing the cellulosic fiber known as Z-Trim was to provide zero calories, the only sweeteners mentioned in U.S. Pat. No. 5,766,662 were the generic name of them, sugars, and in patent application number 20050238781 only dextrose was mentioned. All of these have four calories per gram, so having a zero-calories sweetener as an integral part of the packaged marketable product would be new art. For proof, Z-Trim is only being marketed without a sugar of any kind being attached, so this must be the limitation of obviousness to those skilled in the arts. The marketers only planned to incorporate dextrose in a product such as was mentioned in 20050238781. This would not render the product sought in the application to be of the lowest calories possible. Since erythritol was available and well known and was even being used in the new product “Shugr”, it would appear obvious that neither Inglett nor Circle Group Holdings, Inc. regarded erythritol as a viable alternative, nor did they explore the reasons why it should be. Furthermore, the fact that erythritol can be combined with Z-Trim before use, and this was disclosed to Circle, it only contemplated packaging Z-Trim entirely by itself, and this is why it contracted with George Foreman Enterprises to sell Z-Trim only and did not disclose to Foreman what had already been disclosed to Circle executives by this inventor.

A generic example of the second embodiment is to take by weight one unit of erythritol, one unit of Z-Trim and 10 units of water, mix them and heat at ±100° C. until the sweetness of the resultant is optimized. The water lost in heating can be replaced, if desired, but the heating itself facilitates homogenizing the result after easy-to-do thorough mixing. When cooled this product can be added to food as desired or can be blended into a foam-like gel and this used. To take a specific example of the second embodiment mentioned above by grams, take 10 grams of Z-Trim, 10 grams of erythritol and 100 grams of water and mix into a microwavable container and heat on high for three minutes; replace the lost water, which could be figured by weighing the contents before heating and again afterwards. Then the entire hot contents are mixed again and allowed to cool. This is about four ounces of finished product and can be put in a container large enough to hold it and stored in the refrigerator if to be used with ice cream, ice milk, or yogurt and used at room temperature for warmer foods. The cooked contents can also be placed in a blender and blended into a gel-foam, but if there is too much water present, water needs to be removed and less used.

A second example of the first embodiment, is to take 10 grams of Z-Trim, 10 grams of erythritol and 100 grams of water and mix thoroughly. The resultant can either be packaged or used in bulk or packaged in tubs as used for cottage cheese and sour cream or other appropriate container for home use. This is about four ounces of finished product and can be put in a container large enough to hold it and stored in the refrigerator if to be used with ice cream, ice milk, or yogurt and stored at room temperature for warmer foods. The mixture can also be placed into a blender for a gel-foam as long as it is not too dilute. If it is found to be too dilute, reduce the water content and re-blend.

The ratio of 1:5 Z-Trim to water works well but combining erythritol with it at 1:1:10 can place a burden on the Z-Trim to accommodate the water. Therefore, for home packaging the ratio of 0.8:1.2:6 (Z-Trim:erythritol:water) or close to it may be optimum for this purpose, but when food is prepared in bulk, more water may be able to be used in certain foods for cost-effectiveness. Therefore, we will further discuss the more dilute mixture in that context.

To compare the cooked or boiled combination with the uncooked at the 1:1:10 ratio of ingredients, the “raw” mixture mixes with difficulty and remains non-uniform, but when put into a microwave oven on high for a few minutes before replacement water is added, it cooks to a uniform mass that concentrates in the center of the hot water. If mixed and allowed to cool, the result will be a uniform paste-like substance that can mix readily with both yogurt and mayonnaise, keeping the taste of the two diverse products still acceptable even if somewhat changed. If a gel-foam product is desired to be used, the heated contents with or without replacement water are put in a blender and blended into a foamy result which is used on a volume basis to replace part of the desired food.

If the Z-Trim by itself is converted into a gel-foam by mixing 3½ ounces of it with 16 ounces of water in a blender for several minutes, 3½ ounces of erythritol may be then mixed into the gel followed by up to 16 ounces more of water and a zero-calories fat replacer or diluter made for industrial food purposes. If better texture is achieved, the blending can occur with all ingredients to begin with. Even more erythritol may be used if greater sweetness is desired. Once again by boiling first, the result will better homogenize and be rendered somewhat sweeter than the mix unboiled, and it can be blended in a mechanical blender also.

Z-Trim powder is of greater cost than erythritol but because of Z-Trim's great hygroscopic capability it can accommodate erythritol's lack of hygroscopy. Therefore, one part of Z-Trim can accommodate several parts of erythritol. To replace mostly fat we can keep the erythritol content lower, but to replace mostly sugar, we can keep it higher. Thus if we were going to dilute mayonnaise optimally, we would use one part Z-Trim and one part or less of erythritol, but to dilute yogurt optimally we might want up to several parts erythritol.

When erythritol is cooked with Z-Trim there appears to be bonding by water of some sort but not as a result of caramelizing since erythritol does not caramelize. Temperatures above body temperature are needed for the special bonding, and it certainly happens at 100° C., but changes can be noted at lower temperatures even at 65° C. Nevertheless, since the product is mostly water, if it is cooked or boiled at ±100° C., thus brought to the boiling point of water and maintained there over a set period of time, a faster and more uniform result occurs.

A more concentrated example is to take one part of Z-Trim powder, one part of erythritol and five parts of water all by weight. Once again this mixture can be boiled, mixed at room temperature and either one blended. This product depending on which process is used will result in a similar-looking combination but will be sweeter. Nevertheless, combining erythritol with Z-Trim enables there to be more body than when either is used alone, and it makes a more satisfactory fat replacer than Z-Trim by itself. Since Z-Trim is more expensive than erythritol, combining two parts of erythritol with one part of Z-Trim can still hold a two parts combined substance and five parts water for a fairly concentrated sweeter blend. With the first example in which 10 parts of water is combined with two parts combined substance keeping the Z-Trim at a 50-50 combination makes a good result for average use, including industrial. Cost and taste restraints will dictate the preferred practical combination ratios.

The example of one part of powdered Z-Trim with several or more parts of erythritol to the point of saturating the Z-Trim with erythritol, heated up to liquefaction then cooled, can make a zero-calorie sweetener for cooking or baking to substitute for pure erythritol by itself. Up to one part of water may be included in the mix if attracting water from the atmosphere during heating is not sufficient for optimum texture. Even a 1:10 Z-Trim:erythritol ratio, liquefied by heat, then cooled and pulverized, can substitute for erythritol.

Other polyols can be substituted for erythritol in the same proportions with Z-Trim, but the results will not be zero calories.

It must be remembered that this disclosure concerns a patented substance, Z-Trim, and a public domain substance, erythritol. If by adding erythritol to Z-Trim and boiling the two with water, a new molecular hydrate is formed of the cooked combination, this disclosure plays a part in future disclosures of the molecular discoveries. On the other hand, if not, then this invention discloses a method of combining the two solid ingredients with water and stirring into a homogenized hydrated mix by boiling the contents until uniformity is assured. If replacement of water boiled off is to be added, there may require additional heat or by experimentation start out with enough extra water.

Since many pets and other small domesticated animals are overfed and may become obese as well as diabetic, the disclosures of this invention can be used in their food by simply mixing it in at any proportion that will reduce the food intake while allowing the owners to continue to please themselves and overcome guilt feelings by feeding their animals too much.

Finally, mixing anhydrous D-ribose, which is not a polyol, into the mix of erythritol and Z-Trim can improve both taste and texture of the diluted food and can be used all by itself with Z-Trim or both combined with any polyol.

While particular variations of the present invention have been described, it will be obvious to those skilled in the art that changes and modifications may be made without departing from my invention in its broader aspects of combining Z-Trim, erythritol and water with or without heat and with or without mechanical blending to form a virtually zero-calories fat replacer.

What is claimed is:

1. The combination of the zero-calories prebiotic cellulosic fiber, Z-Trim, with the essentially zero-calories polyol, erythritol to form a sweeter zero-calories fat replacer than Z-Trim used alone.

2. The invention according to claim 1 in which water is added.

3. The invention according to claim 1 in which Z-Trim, erythritol and water are mixed at room temperature.

4. The invention according to claim 1 in which Z-Trim, erythritol and water are mixed and then subjected to elevated temperatures.

5. The invention according to claim 1 in which with water the contents can be blended in a mechanical blender.

6. The invention according to claim 1 in which there can be more Z-Trim than erythritol.

7. The invention according to claim 1 in which there can be more erythritol than Z-Trim.

8. The invention according to claim 1 in which there can be more water than either erythritol or Z-Trim.

9. The invention according to claim 1 in which there can be more water than erythritol and Z-Trim combined.
